(19) United States
(12) Patent Application Publication
(10) Pub. No.: US 2011/0072215 A1
(43) Pub. Date: Mar. 24, 2011

(54) Cache system and control method of way prediction for cache memory

(75) Inventor: Daisuke Takahashi, Kanagawa (JP)

(73) Assignee: Renesas Electronics Corporation, Kawasaki (JP)

(21) Appl. No.: 12/923,385

(22) Filed: Sep. 17, 2010

(30) Foreign Application Priority Data
Sep. 18, 2009 (JP) 2009-216570

(51) Int. Cl. G06F 12/08; G06F 9/32

(52) U.S. Cl. 711/125; 712/241; 712/E09.078; 711/E12.023

(57) ABSTRACT

A cache device according to an exemplary aspect of the present invention includes a way information buffer that stores way information that is a result of selecting a way in an instruction that accesses a cache memory; and a control unit that controls a storage processing and a read processing, while a series of instruction groups are repeatedly executed, the storage processing being for storing the way information in the instruction groups to the way information memory, the read processing being for reading the way information from the way information memory.

### INCORPORATION BY REFERENCE

This application is based upon and claims the benefit of priority from Japanese patent application No. 2009-216570, filed on Sep. 18, 2009, the disclosure of which is incorporated herein in its entirety by reference.

### BACKGROUND

1. Field of the Invention

The present invention relates to a cache system and a control method of way prediction for a cache memory. In particular, the present invention relates to a cache system and a control method of way prediction for a cache memory to make a way prediction.

2. Description of Related Art

In recent years, the number of semiconductor devices equipped with a cache device including a cache memory has been increasing, for the improvement of the operation performance of the semiconductor device. The cache device makes so-called cache access to access a main memory through a cache memory, in response to a memory access request from a processor. However, during the cache access, a plurality of tag memories or data memories included in the cache memory are accessed at the same time, so the number of accesses to a plurality of RAMs (Random Access Memories) in the cache memory increases. Therefore, the amount of power consumption of the semiconductor device also increases. Thus, the demand for designing a semiconductor device that takes energy saving into consideration in view of a problem, such as generation of heat, has been increasing. In particular, there is known a method to reduce a number of accesses to a cache memory, by making a way prediction during the cache access, in order to realize low power consumption.

For example, Japanese Unexamined Patent Application Publication No. 2006-120163 discloses a technology related to a device to reduce power consumption associated with cache access, by making a way prediction using a memory address buffer, a circuit to disable tag access (hereinafter, referred to as “tag disable circuit”), a circuit to disable way access (hereinafter, referred to as “way disable circuit”), and a cache memory. Hereinafter, the technology of Japanese Unexamined Patent Application Publication No. 2006-120163 is explained with reference to FIGS. 7, 8, and 9.

FIG. 7 is a block diagram showing a configuration of a cache device according to Japanese Unexamined Patent Application Publication No. 2006-120163. A system 10 includes a processor 12 and a main memory (not shown). The processor 12 includes a cache memory 14. The main memory and the cache memory 14 are coupled to each other with an address bus and a data bus. The cache memory 14 is a two-way associative cache memory. The cache memory 14 includes a memory address 18, a way 22, a way 24, and multiplexers 30, 32, and 34. The memory address 18 includes a tag, a set-index, and an offset. For example, in FIG. 7, the tag is 18 bits, the set-index is 9 bits, and the offset is 5 bits. The ways 22 and 24 each include a tag memory and a data memory. For example, in FIG. 7, the tag memory is 18 bits and 512 lines, and the data memory is 256 bits and 512 lines.

In general, a way is a combination of a tag memory and a data memory. Further, the performance can be improved by providing a plurality of ways to a cache memory.

Hereinafter, a normal access method to a cache memory in the system 10 is explained. First, the set-index included in the memory address 18 corresponds to each line of the ways 22 and 24. That is, the cache memory 14 can select a tag memory and a data memory of the corresponding ways 22 and 24, based on the set-index. Further, the cache memory 14 compares the selected tag memory of each of the ways 22 and 24 with a tag of the memory address 18. Furthermore, the cache memory 14 determines which of the tag memory of the way 22 and the tag memory of the way 24 corresponds to the tag of the memory address 18. The multiplexers 30 and 32 output an output object data based on a data memory of each of the ways 22 and 24, which are selected based on the set-index, and based on the offset of the memory address 18, to the multiplexer 34. Further, the multiplexer 34 selects and outputs the output object data from one of the tag memory of the way 22 and the tag memory of the way 24 corresponding to the tag of the memory address 18. When the tag of the memory address 18 does not match both the tag memory of the way 22 and the tag memory of the way 24, a cache miss occurs, and the processor 12 refers to the main memory to extract the data.

In such an access method, whenever the cache memory 14 is accessed, energy is consumed, and an electric power is consumed. For this reason, the system 10 executes a method to reduce redundant access to the ways 22 and 24, in order to reduce power consumption. Therefore, the system 10 makes a way prediction by providing a memory address buffer to memorize an access address accessed before.

FIG. 8 is a block diagram showing a concept of a way prediction with a memory address buffer according to Japanese Unexamined Patent Application Publication No. 2006-120163. A memory address buffer 38 is a buffer to hold a 27-bit address area and information for identifying a way of at least 1 bit, for example, a way number. The tag and set-index corresponding to 27 bits in the memory address 18 of an MRU address are stored in the address area. When the MRU address is subjected to cache access and makes a cache hit, a way is selected, and the selected result of the way is stored in the way number. FIG. 8 shows only the ways 22 and 24 in the cache memory 14 of FIG. 7, for the purpose of illustration. Hatching areas of a tag memory and a data memory of the ways 22 and 24 represent lines corresponding to each address area of the memory address buffer 38. That is, in the example of FIG. 8, an address-1, an address-3, and an address-4 of the memory address buffer 38 each correspond to the way number “0” representing the way 22, and an address-2 corresponds to the way number “1” representing the way 24.

Subsequently, an exemplary operation of the way prediction is explained with reference to FIG. 8. First, when a certain address accesses the cache memory 14 and makes a cache hit, the cache memory 14 stores the address and the way number which have made a cache hit to the memory address buffer 38. For example, when the address-2 of the way 24 makes a cache hit, the cache memory 14 stores information indicating the address-2 and “1” representing the way number to the memory address buffer 38. Thereafter, when the address-2 makes a cache access again, the cache memory 14 refers to the memory address buffer 38, and confirms that the address-2 has been subjected to cache access before. That is, the cache memory 14 can acknowledge that the address has been cached in the ways 22 and 24 without accessing the main memory. Further, the cache memory 14 can acknowledge that the address has been cached in the way 24, by the way number stored corresponding to the address-2 from the memory address buffer 38. That is, the cache memory 14 can predict a way to be cached from an address of a cache access target. A value stored in the memory address buffer 38 is updated when a new address is subjected to cache access.

FIG. 9 is a block diagram showing an example of a way prediction device according to Japanese Unexamined Patent Application Publication No. 2006-120163. The way prediction device of FIG. 9 includes an additional circuit 50, an original circuit 60, and a cache memory 14. Note that the cache memory 14 is similar to FIG. 7, and therefore an explanation thereof is omitted.

The original circuit 60 receives a base address 62 which is a basic address and a displacement 64 which is a displacement component (that is, a displacement address or a displacement value) from the base address 62, generates a target address 65 by a 32-bit ALU 63, and accesses the cache memory 14. A process for generating the target address 65 in the original circuit 60 is referred to as an address generation stage.

The additional circuit 50 includes a memory address buffer 38, a tag disable circuit 51, and a way disable circuit 52. The memory address buffer 38 includes a way number 39. The additional circuit 50 receives the base address 62 and the displacement 64 during the address generation stage, determines whether an address hits in the memory address buffer 38, and controls the cache memory 14 with the tag disable circuit 51 and the way disable circuit 52 according to the determination result. The tag disable circuit 51 disables a tag memory in the cache memory 14, when an address hits in the memory address buffer 38. The way disable circuit 52 disables a data memory in the cache memory 14, when an address hits in the memory address buffer 38.

In this way, the cache memory 14 shown in FIG. 9 can omit an unnecessary tag and way access, when an address hits in the memory address buffer 38.

Note that the above-mentioned method is based on the assumption that a target address is a sum of the base address 62 and the displacement 64, and that a small value is generally taken. Further, the value is typically small. In particular, many displacement values are smaller than 14th power of 2. Therefore, a tag value can be easily calculated without generating an address. This is achieved by inspecting upper 18 bits of the base address, code extension of the displacement, and a carry bit of a 14-bit adder. The adder adds lower 14 bits of the base address and the displacement. Therefore, a delay of the additional circuit 50 is equal to a sum of a delay of the 14-bit adder and a delay of access to a set-index table. Generally, this delay is smaller than a delay of the 32-bits adder to be used for calculating an address.

In addition, Japanese Unexamined Patent Application Publication No. 2006-343803 discloses a technology related to a cache memory to make a way prediction with a main address register, a sub address register, a latch circuit, a comparator, and a control circuit. In particular, the cache memory according to Japanese Unexamined Patent Application Publication No. 2006-343803 holds an address executed previously in the sub address register. The comparator compares an address held in the main address register and an address held in the sub address register. The cache memory selects any of a plurality of data items held in the latch circuit according to the comparison result and outputs the selected data as hit data of the cache.

### SUMMARY

However, the present inventor has found a problem that a serious problem may be caused by a runaway of a program and system malfunctions, if the way prediction fails in the system equipped with the cache device, in Japanese Unexamined Patent Application Publication No. 2006-120163.

The way prediction device according to Japanese Unexamined Patent Application Publication No. 2006-120163 makes the way prediction by simply calculating an address using only the lower 14 bits of the base address 62 and the displacement 64, and comparing the calculated address with the address stored in the memory address buffer 38. Thus, the way prediction device cannot properly calculate the address, when a carrying-over to the 15th bit occurs in the address calculation. If a wrong address matches an address stored in the memory address buffer 38, the system cannot detect the wrong address and performs processing using the wrong cached data, which causes malfunctions in the system. Note that, in Japanese Unexamined Patent Application Publication No. 2006-120163, only the lower 14 bits are used to calculate an address, because the system cannot complete the comparison processing with the memory address buffer 38 within one cycle, if the system uses all of the 32 bits.

Additionally, in the cache memory according to Japanese Unexamined Patent Application Publication No. 2006-343803, the sub address register holds only an address accessed previously. This makes it impossible to fully achieve the way prediction.

A first exemplary aspect of the present invention is a cache system including: a way information memory unit that stores way information that is a result of selecting a way in an instruction that accesses to a cache memory; and a control unit that controls a storage processing and a read processing, while a series of instruction groups are repeatedly executed, the storage processing being for storing the way information in the instruction group to the way information memory, the read processing being for reading the way information from the way information memory.

A Second exemplary aspect of the present invention is a control method of way prediction for a cache memory in a cache device, including: a cache memory; a way information buffer that stores way information that is a result of selecting a way in an instruction that accesses the cache memory; and a control unit that controls an operation of the way information buffer, the control method including: storing, by the control unit, the way information in a series of instruction groups to the way information buffer, while the instruction groups are repeatedly executed; and reading, by the control unit, the way information from the way information buffer, while the instruction groups are repeatedly executed.

As described above, in accordance with the first and second exemplary aspects of the present invention, the way prediction is made not by address matching, but by storing only the way information in the instruction group to be repeatedly executed continuously. Therefore, only the way information of the instruction group is to be read. Consequently, the way prediction can be reliably made while the instruction group is repeatedly executed continuously.

The present invention can provide a cache system and a control method of a way prediction for a cache memory capable of reducing the occurrence of failure of the way prediction and preventing the system from causing a malfunction.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing a configuration of a cache device according to a first exemplary embodiment of the present invention;

FIG. 2 is a block diagram showing a configuration of a control circuit according to the first exemplary embodiment of the present invention;

FIG. 3 is a flowchart showing a process flow of cache access according to the first exemplary embodiment of the present invention;

FIG. 4 is a flowchart showing a process flow of an event wait condition detection processing according to the first exemplary embodiment of the present invention;

FIG. 5 is a timing diagram showing a process before starting cache access according to the first exemplary embodiment of the present invention;

FIG. 6 is a timing diagram showing a process for detecting termination of an event wait condition detection according to the first exemplary embodiment of the present invention;

FIG. 7 is a block diagram showing a configuration of a cache device according to related art;

FIG. 8 is a block diagram showing a concept of a way prediction with a memory address buffer according to related art; and

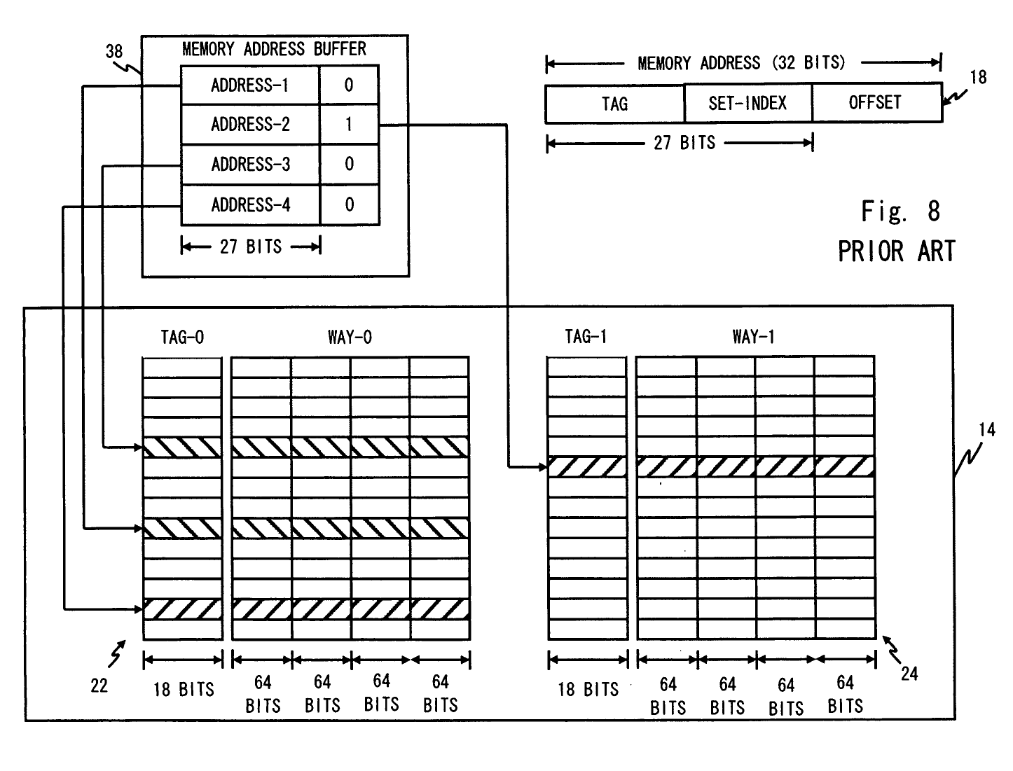

FIG. 9 is a block diagram showing an example of a way prediction device according to related art.

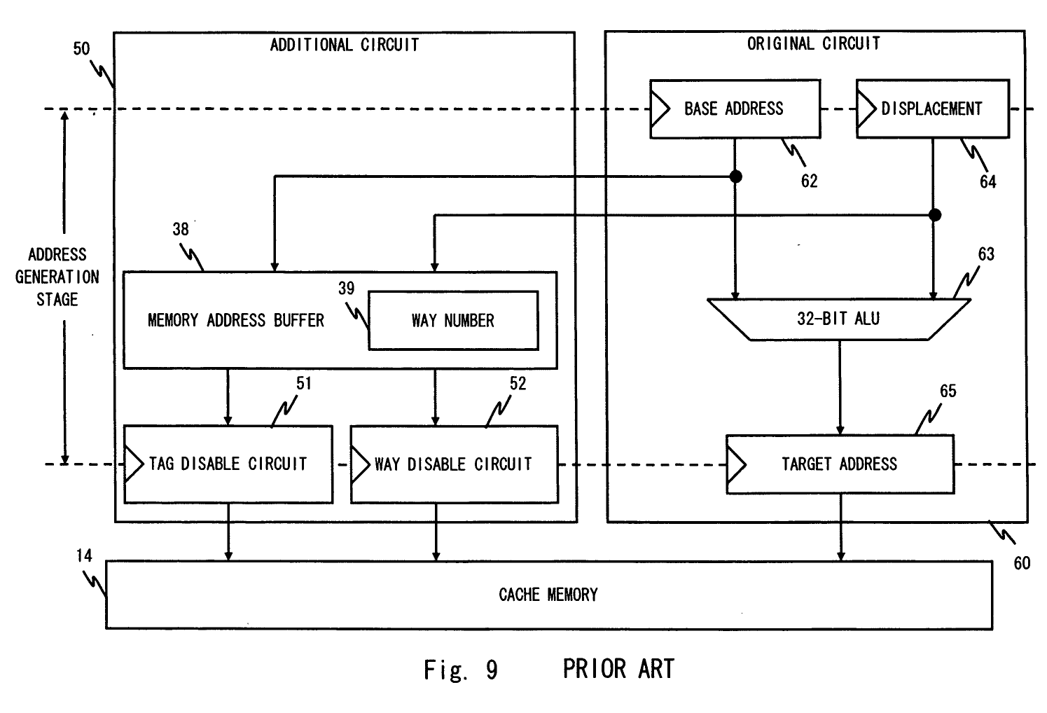

### DETAILED DESCRIPTION OF THE EXEMPLARY EMBODIMENTS

Exemplary embodiments to which the present invention are explained hereinafter in detail with reference to the drawings. The same components are denoted by the same reference numerals throughout the drawings, and duplicated explanation thereof is omitted as appropriate for clarifying the explanation.

### First Exemplary Embodiment

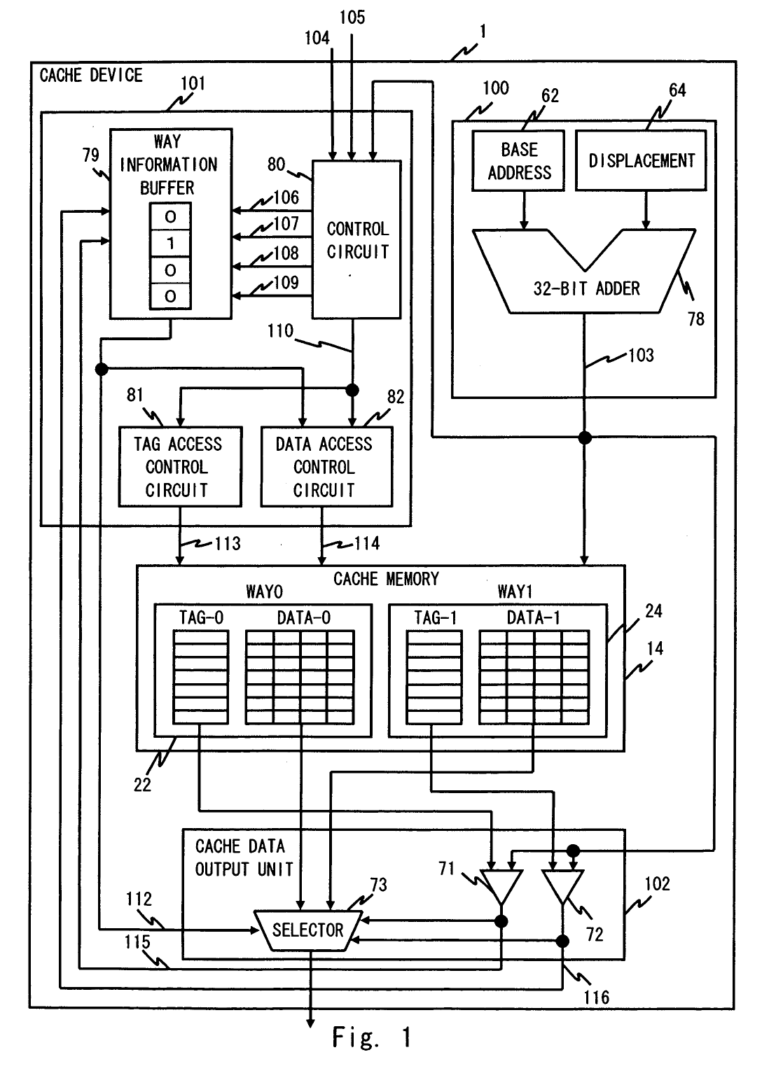

FIG. 1 is a block diagram showing a configuration of a cache device 1 which is an example of a cache system according to a first exemplary embodiment of the present invention. For example, the cache device 1 may be mounted on a semiconductor device or the like, and may be used with a control device such as a processor (not shown). The cache device 1 includes an address calculation unit 100, a way information administration unit 101, a cache memory 14, and a cache data output unit 102.

The address calculation unit 100 includes a base address 62, a displacement 64, and a 32-bit adder 78. The address calculation unit 100 outputs a target address 103 to access to the cache memory 14. The 32-bit adder 78 receives the base address 62 and the displacement 64, and generates the target address 103 by an addition processing. The 32-bit adder 78 outputs the target address 103 to the cache memory 14, the way information administration unit 101, a tag-0 comparator 71, and a tag-1 comparator 72.

The way information administration unit 101 makes a way prediction. The way information administration unit 101 includes a way information buffer 79, a control circuit 80, a tag access control circuit 81, and a data access control circuit 82. The way information buffer 79 is a memory unit that stores way information that is a result of selecting a way in an instruction which accesses the cache memory 14. The way information buffer 79 selects one of way information 115 and way information 116 to be output from the cache data output unit 102, according to an instruction from the control circuit 80, and stores and reads the selected way information. In particular, the way information buffer 79 stores and reads the way information only in an event wait condition. Specifically, the way information buffer 79 receives a way information store pointer 106, a way information read pointer 107, a way information store enabling signal 108, and a way information read enabling signal 109 from the control circuit 80, and receives the way information 115 from the tag-0 comparator 71 and the way information 116 from the tag-1 comparator 72. The control circuit 80 outputs way selection information 112 to the data access control circuit 82 and a selector 73.

The control circuit 80 is a control unit that detects the event wait condition, controls storing and reading of the way information to the way information buffer 79, and controls access to a tag and a data memory. The control circuit 80 receives the target address 103, an executive instruction 104, and a branch destination address 105 in the branch instruction as input signals. The executive instruction 104 and branch destination address 105 are supplied from the outside of the cache device 1. The control circuit 80 outputs the way information store pointer 106, the way information read pointer 107, the way information store enabling signal 108, and the way information read enabling signal 109 to the way information buffer 79. The control circuit 80 outputs an access control signal 110 to the tag access control circuit 81 and the data access control circuit 82.

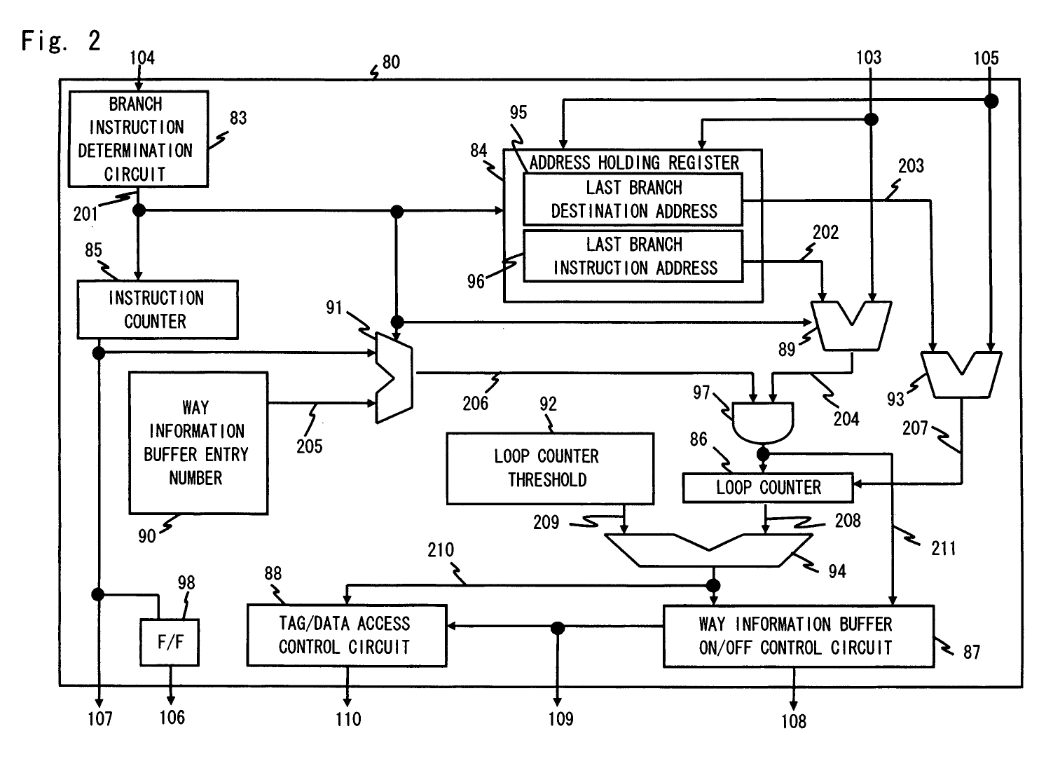

In other words, while a series of instruction groups are being repeatedly executed, the control circuit 80 controls a storage processing to store the way information in the instruction group to the way information buffer 79, and a read processing to read the way information from the way information buffer 79. Further, the control circuit 80 detects that the instruction group is being repeatedly executed, from a plurality of instructions to be supplied, and upon the detection, the control circuit 80 controls the storage processing and the read processing. Note that an internal configuration of the control circuit 80 is explained in detail with reference to FIG. 2.

The tag access control circuit 81 controls access to the tag of the cache memory 14. In particular, the tag access control circuit 81 receives the access control signal 110, and outputs a tag access disable signal 113 to the cache memory 14. The data access control circuit 82 controls access to data of the cache memory 14. In particular, the data access control circuit 82 receives the access control signal 110 and the way selection information 112, and outputs a data access control signal 114 to the cache memory 14.

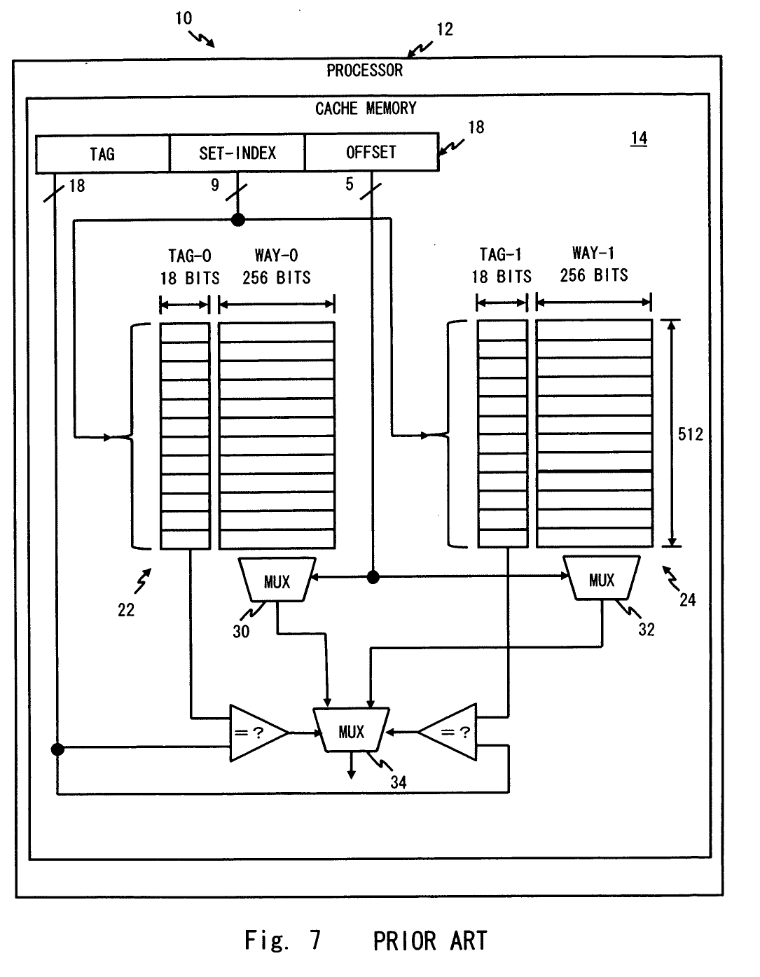

The cache memory 14 includes ways 22 and 24. The way 22 includes a tag memory (hereinafter, referred to as “tag-0”) and a data memory (hereinafter, referred to as “data-0”). The way 24 includes a tag memory (hereinafter, referred to as “tag-1”) and a data memory (hereinafter, referred to as “data-1”). The cache memory 14 may be a RAM (Random Access Memory), a ROM (Read Only Memory), an EPROM (Erasable Programmable Read Only Memory), an EEPROM (Electrically Erasable and Programmable Read Only Memory), an FCRAM (Fast Cycle RAM), an SRAM (Static Random Access Memory), or any other appropriate object capable of supporting these storing operations. As other examples, the cache memory 14 may be replaced by another processor or software, or may interface with a processor by a similar format to be outlined here. Additionally, the cache memory 14, the ways 22 and 24 are similar to those of FIG. 7, and therefore an explanation thereof is omitted.

The cache data output unit 102 includes the tag-0 comparator 71, the tag-1 comparator 72, and the selector 73. The tag-0 comparator 71 receives the tag-0 of the cache memory 14 and the target address 103, and outputs a comparison result of the tag-0 and the target address 103 as the way information 115 to the way information buffer 79 and the selector 73. The tag-1 comparator 72 receives the tag-1 of the cache memory 14 and the target address 103, and outputs a comparison result of the tag-1 and the target address 103 as the way information 116 to the way information buffer 79 and the selector 73. The selector 73 receives the data-0 and the data-1 of the cache memory 14, the way information 115, the way information 116, and the way selection information 112, and outputs the instruction read from the cache memory 14 to the outside of the cache device 1. When the way selection information 112 is low level, the selector 73 selects and outputs one of the data-0 and data-1 according to the way information 115 and the way information 116. Alternatively, when the way selection information 112 is high level, the selector 73 outputs the input data, because the selector 73 receives only one of the data-0 and data-1.

FIG. 2 is a block diagram showing a detailed internal configuration of the control circuit 80 according to the first exemplary embodiment of the present invention. The control circuit 80 includes a branch instruction determination circuit 83, an address holding register 84, an instruction counter 85, a loop counter 86, a way information buffer on/off control circuit 87, a tag/data access control circuit 88, a branch instruction address comparator 89, a way information buffer entry number holding register 90, a instruction count number comparator 91, a loop counter threshold holding register 92, a branch destination address comparator 93, a loop count number comparator 94, a loop counter addition controller 97, and a flip flop 98.

The branch instruction address comparator 89 and the address holding register 84 receive the target address 103 supplied from the address calculation unit 100 of FIG. 1. The branch instruction determination circuit 83 receives the executive instruction 104 supplied from the outside of the cache device 1. The branch destination address comparator 93 and the address holding register 84 receive the branch destination address 105 supplied from the outside of the cache device 1.

The branch instruction determination circuit 83 determines whether the executive instruction is a branch instruction. In particular, the branch instruction determination circuit 83 receives the executive instruction 104, and outputs a branch instruction detection signal 201 to the instruction counter 85, the address holding register 84, the branch instruction address comparator 89, and the instruction count number comparator 91. When determining that the executive instruction 104 is a branch instruction, the branch instruction determination circuit 83 sets the branch instruction detection signal 201 to high. When determining that the executive instruction 104 is not a branch instruction, the branch instruction determination circuit 83 sets the branch instruction detection signal 201 to low.

The instruction counter 85 counts the number of executive instructions. In particular, the instruction counter 85 receives the branch instruction detection signal 201, and outputs the way information read pointer 107 and the way information store pointer 106 to the way information buffer 79 of FIG. 1. The way information store pointer 106 is obtained delaying the way information read pointer 107 by one cycle by the flip flop 98. When the branch instruction detection signal 201 is high, the instruction counter 85 resets the value of the instruction counter. That is, the instruction counter 85 counts the number of executive instructions within the same instruction loop.

The address holding register 84 is a register including a last branch instruction address holding register 96 and a last branch destination address holding register 95. The address holding register 84 receives the target address 103, the branch destination address 105, and the branch instruction detection signal 201. The address holding register 84 outputs a value stored in the last branch instruction address holding register 96 as a last branch instruction run address 202 to the branch instruction address comparator 89, and outputs a value stored in the last branch destination address holding register 95 as a last branch destination address 203 to the branch destination address comparator 93. Further, when the branch instruction detection signal 201 is high, the address holding register 84 updates the value stored in the last branch instruction address holding register 96 by the target address 103, and updates the value stored in the last branch destination address holding register 95 by the branch destination address 105.

The branch instruction address comparator 89 receives the target address 103, the last branch instruction run address 202, and the branch instruction detection signal 201, and outputs an address match signal 204 to the loop counter addition controller 97.

The way information buffer entry number holding register 90 is a register holding a maximum entry number of the way information buffer 79. The way information buffer entry number holding register 90 outputs a way information buffer entry number 205 to the instruction count number comparator 91.

The instruction count number comparator 91 receives the way information read pointer 107, the way information buffer entry number 205, and the branch instruction detection signal 201, and outputs an entry enabling signal 206 to the loop counter addition controller 97.

The loop counter addition controller 97 receives the address match signal 204 and the entry enabling signal 206, and outputs a loop counter addition enabling signal 211 to the loop counter 86 and the way information buffer on/off control circuit 87.

The branch destination address comparator 93 receives the branch destination address 105 and the last branch destination address 203, and outputs a branch destination mismatch signal 207 to the loop counter 86.

The loop counter 86 counts the number of executed instruction loops. The loop counter 86 receives the loop counter addition enabling signal 211 and the branch destination mismatch signal 207, and outputs a loop count number 208 to the loop count number comparator 94.

The loop counter threshold holding register 92 is a register holding a loop counter threshold. The loop counter threshold holding register 92 outputs a loop counter threshold 209 to the loop count number comparator 94.

The loop count number comparator 94 receives the loop count number 208 and the loop counter threshold 209, and outputs an event wait condition detection signal 210 to the way information buffer on/off control circuit 87 and the tag/data access control circuit 88.

The way information buffer on/off control circuit 87 controls storing and reading of the way information buffer 79. The way information buffer on/off control circuit 87 receives the loop counter addition enabling signal 211 and the event wait condition detection signal 210, outputs the way information store enabling signal 108 to the way information buffer 79, and outputs the way information read enabling signal 109 to the way information buffer 79 and the tag/data access control circuit 88.

The tag/data access control circuit 88 receives the event wait condition detection signal 210 and the way information read enabling signal 109, and outputs the access control signal 110 to the tag access control circuit 81 and the data access control circuit 82.

That is, upon detecting that the instruction group is repeatedly executed, the control circuit 80 starts a storage processing for the way information in the instruction group. After the storage processing is started, when the control circuit 80 detects that the instruction group is executed again, the control circuit 80 starts a read processing. Thus, the cache device 1 can reliably read the way information stored in the way information buffer 79.

Additionally, upon detecting that the same instruction group is executed immediately after the instruction group detected has been executed, the control circuit 80 starts the read processing. Thus, the cache device 1 can start the read processing before the storage processing is completed. Therefore, it is possible to reduce unnecessary cache memory access. Further, for example, even if the cache device 1 does not complete the storage processing for all the plurality of instructions, a cache access processing can be carried out using a result of way prediction more quickly by reading instructions initially stored.

Moreover, when determining that the same branch instruction is periodically executed, the control circuit 80 detects that the instruction group is being repeatedly executed. This eliminates the necessity to determine all instructions belonging to the instruction loop, and makes it possible to detect the repetition by a minimum determination and to reduce a load of detection processing.

Furthermore, when a branch destination address included in the detected instruction group does not match a branch destination address included in the instruction group obtained after the read processing is started, the control circuit 80 terminates the read processing. Thus, it is possible to properly detect the end of repetition of the instruction loop.

Further, the control circuit 80 controls the storage processing to store the way information of each instruction belonging to the instruction group to the way information buffer 79 in the order of execution of the instructions. Subsequently, the control circuit 80 controls the read processing to read the stored way information from the way information buffer 79 in the order storage in the way information buffer 79. Thus, it is possible to reliably read the way information according to the order of execution of the instruction groups. Therefore, it is possible to improve the accuracy of the way prediction.

Furthermore, the control circuit 80 may include at least a branch instruction determination circuit that decodes a plurality of instructions to be supplied and determines whether the instruction to be decoded is a branch instruction or not; a branch instruction address holding circuit that holds an address of a branch instruction executed previously; a branch destination address holding circuit that holds an address of a branch destination of the branch instruction; an instruction counter counts up upon each execution of one instruction and is reset when the instruction is determined as a branch instruction; and a loop counter that is used for a loop control of the plurality of instructions to be repeatedly executed.

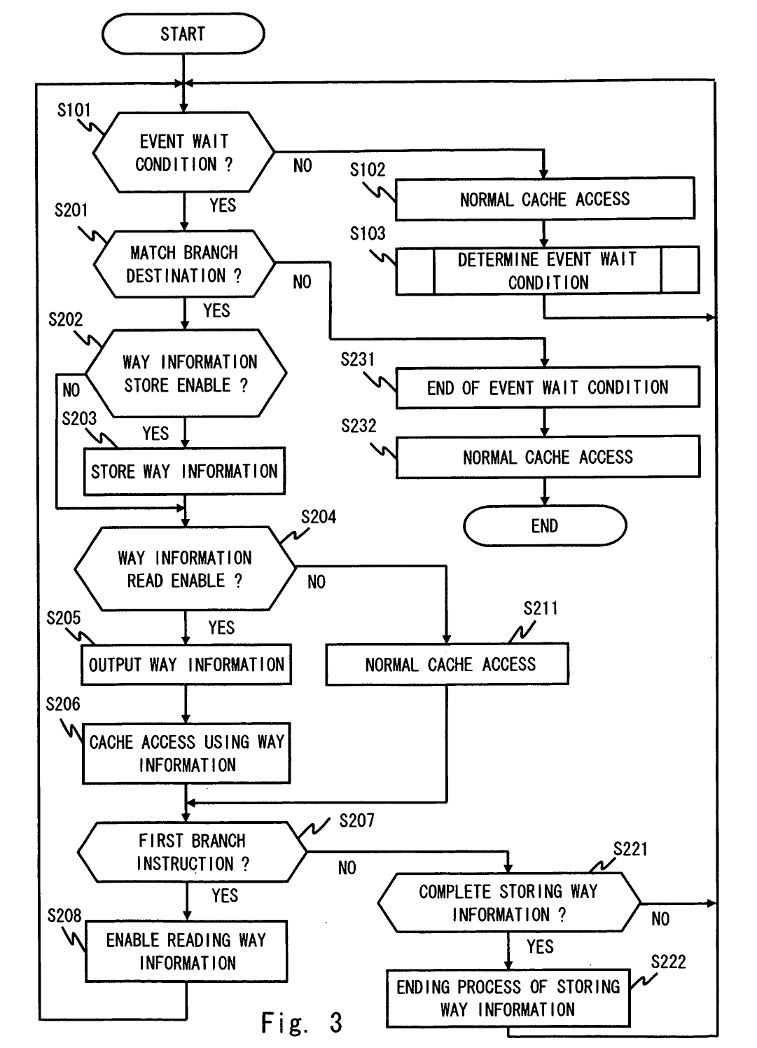

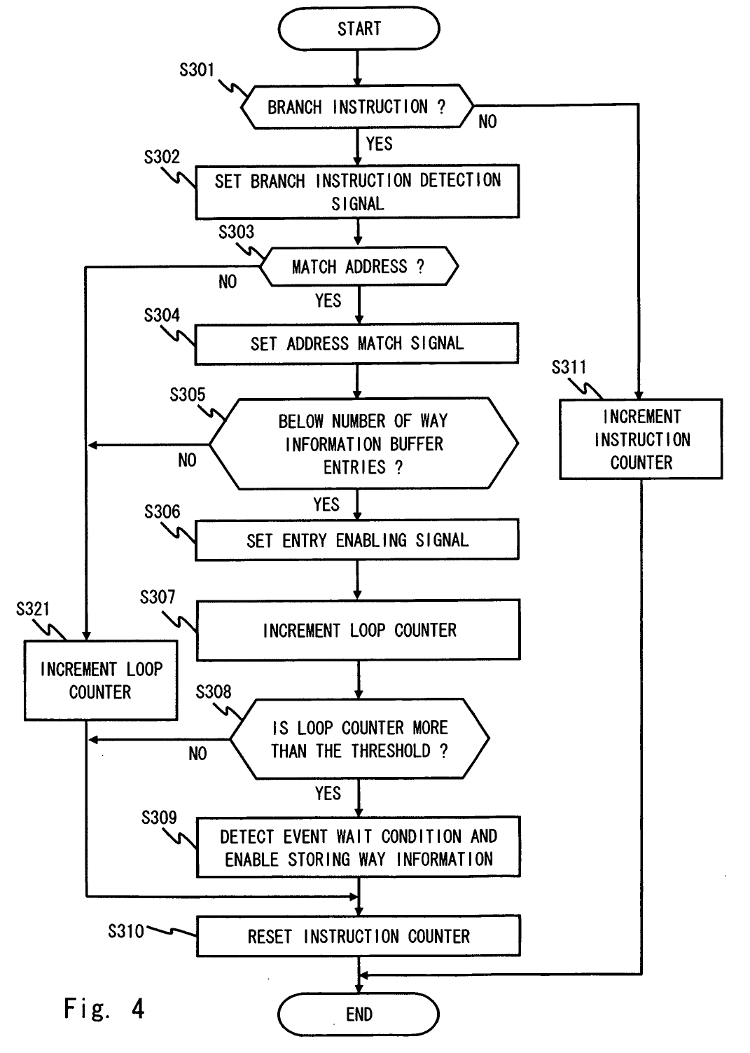

Hereinafter, operations of FIGS. 1 and 2 are explained with reference to FIGS. 3 and 4. In a system equipped with a pipeline, when a branch instruction is executed and a branch destination address is calculated, the pipeline falls into disorder. Therefore, it is general to execute also a next instruction (hereinafter, referred to as “delay slot instruction”) of the branch instruction. The cache system according to the first exemplary embodiment of the present invention has a pipeline structure, has no branch prediction capability, and executes the delay slot instruction upon execution of the branch instruction.

FIG. 3 is a flowchart showing a process flow of cache access according to the first exemplary embodiment of the present invention. First, when the way information administration unit 101 receives the target address 103, the way information administration unit 101 determines whether an event wait condition is detected or not (S101). For example, when the event wait condition detection signal 210 is high, the control circuit 80 determines that the event wait condition is detected. When the event wait condition detection signal 210 is low, the control circuit 80 determines that the event wait condition is not detected. Note that the determination of the step S101 is not limited to the above.

If it is determined that the event wait condition is not detected in the step S101, the way information administration unit 101 executes normal cache access (S102). When the normal cache access is executed, first, the cache memory 14 receives an index part of the target address 103, accesses to all of the tag-0, tag-1, data-0, and data-1, and outputs data. Next, the tag-0 comparator 71 compares a tag part of the target address 103 and data to be output from the tag-0. When the tag part matches the data to be output from the tag-0, the tag-0 comparator 71 sets the way information 115 to high. Similarly, the tag-1 comparator 72 compares a tag part of the target address 103 and data to be output from the tag-1. When the tag part matches the data to be output from the tag-1, the tag-1 comparator 72 sets the way information 116 to high. When the way information 115 is high, the selector 73 outputs the data-0 to the outside of the cache device 1, and when the way information 116 is high, the selector 73 outputs the data-1 to the outside of the cache device 1.

When it is determined that the event wait condition is detected in the step S101, the branch destination address comparator 93 in the control circuit 80 compares the branch destination address 105 and the last branch destination address 203, and determines whether these addresses are identical or not (S201).

If the branch destination address 105 does not match the last branch destination address 203 in the step S201, the branch destination address comparator 93 sets the branch destination mismatch signal 207 to high. The loop counter 86 resets the loop count number 208. The loop count number comparator 94 sets the event wait condition detection signal 210 to low. The way information buffer on/off control circuit 87 sets the way information store enabling signal 108 and the way information read enabling signal 109 to low. The tag/data access control circuit 88 sets the access control signal 110 to low. Thus, the way information administration unit 101 regards the event wait condition as being terminated (S231). After that, the way information administration unit 101 executes normal cache access, and terminates the cache access processing (S232).

When the branch destination address 105 matches the last branch destination address 203 in the step S201, the way information administration unit 101 determines whether the storage of the way information is allowed or not (S202). When the storage of the way information is allowed, the control circuit 80 stores the value of the way information 115 or 116 as the way information of the last cache access to an entry indicated by the way information store pointer 106 in the way information buffer 79 (S203). In particular, when the way information stores enabling signal 108 is high and the way information 115 is high, the way information administration unit 101 stores “0”. When the way information stores enabling signal 108 is high and the way information 116 is high, the way information administration unit 101 stores “1”.

After that, the way information administration unit 101 determines whether reading of the way information is allowed or not (S204). When the reading of the way information is not allowed, that is, when the way information read enabling signal 109 is low, the way information administration unit 101 executes normal cache access (S211).

Meanwhile, when the reading the way information is allowed in the step S204, that is, when the way information read enabling signal 109 is high, the way information administration unit 101 outputs information, stored in an entry indicated by the way information read pointer 107 in the way information buffer 79, as the way selection information 112 (S205).

Subsequently, the way information administration unit 101 executes a cache access using the output way selection information 112 (S206). In particular, the tag access control circuit 81 configures the tag access disable signal 113 to disable tag access of all ways of the cache memory 14. The data access control circuit 82 configures the data access control signal 114 to disable data access to ways other than a way to be indicated by the way selection information 112. The selector 73 outputs data read from the way to be indicated by the way selection information 112, among the ways of the cache memory 114, to the outside of the cache device 1.

After that, the way information administration unit 101 determines whether the read instruction is a first branch instruction after an event wait condition has been detected (S207). When it is determined that the read instruction is the first branch instruction, the way information administration unit 101 allows reading of the way information (S208). In particular, the way information buffer on/off control circuit 87 sets the way information read enabling signal 109 to high. The tag/data access control circuit 88 sets the access control signal 110 to high. The tag access control circuit 81 configures the tag access disable signal 113 to allow tag access of all ways of the cache memory 14. The data access control circuit 82 configures the data access control signal 114 to allow data access of all ways of the cache memory 14. After that, the flow returns to the step S101.

When it is determined that the read instruction is not the first branch instruction, the way information administration unit 101 determines whether the storage of the way information has been completed or not (S221). In particular, the way information administration unit 101 determines whether the storage of the way information has been completed or not, based on the way information store enabling signal 108 and the way information read enabling signal 109. When the storage of the way information has not been completed, the flow returns to the step S101.

When the storage of the way information has been completed in the step S221, that is, when both of the way information store enabling signal 108 and the way information read enabling signal 109 are high, the way information buffer on/off control circuit 87 sets the way information store enabling signal 108 to low, and the flow returns to the step S101 (S222).

FIG. 4 is a flowchart showing a process flow of an event wait condition detection processing according to the first exemplary embodiment of the present invention. First, the branch instruction determination circuit 83 in the control circuit 80 decodes the executive instruction 104, and determines whether the decoded executive instruction is a branch instruction or not (S301). When the decoded executive instruction is not a branch instruction, the control circuit 80 increments the instruction counter 85, and terminates the event wait condition detection processing (S311).

When the decoded executive instruction is a branch instruction in the step S301, the branch instruction determination circuit 83 sets the branch instruction detection signal 201 to high (S302). The address holding register 84 outputs a value stored in the last branch destination address holding register 95 and a value stored in the last branch instruction address holding register 96 as the last branch destination address 203 and the last branch instruction run address 202, to the branch destination address comparator 93 and the branch instruction address comparator 89, respectively. When the branch instruction detection signal 201 is high, the address holding register 84 discards the value stored in the last branch instruction address holding register 96, and stores the target address 103. Similarly, when the branch instruction detection signal 201 is high, the address holding register 84 discards the value stored in the last branch destination address holding register 95, and stores the branch destination address 105.

After that, the instruction count number comparator 91 determines whether the way information read pointer 107, which is a value of an internal counter of the instruction counter 85, is the way information buffer entry number 205 or less (S305). When it is determined that, the way information read pointer 107 is greater than the way information buffer entry number 205, the flow advances to the step S321.

When the way information read pointer 107 is the way information buffer entry number 205 or less in the step S305, the instruction count number comparator 91 sets the entry enabling signal 206 to high (S306). This is because, in this case, it is possible to determine that the number of instructions per one loop of the instruction loop, which is repeatedly executed continuously until just before, is within a range of the number of instructions that can be stored in the way information buffer 79.

The loop counter addition controller 97 sets the loop counter addition enabling signal 211 to high, and increments the loop counter 86 (S307). The loop count number comparator 94 determines whether the loop count number 208 is the loop counter threshold 209 or more (S308). When the loop count number 208 is less than the loop counter threshold 209, the flow advances to the step S310 to terminate the event wait condition detection processing.

When the loop count number 208 is the loop counter threshold 209 or more in the step S308, the control circuit 80 detects the event wait condition, and allows storage of the way information (S309). In particular, the loop count number comparator 94 sets the event wait condition detection signal 210 to high. The way information buffer on/off control circuit 87 sets the way information store enabling signal 108 to high. After that, the control circuit 80 resets the instruction counter 85 (S310), and terminates the event wait condition detection processing.

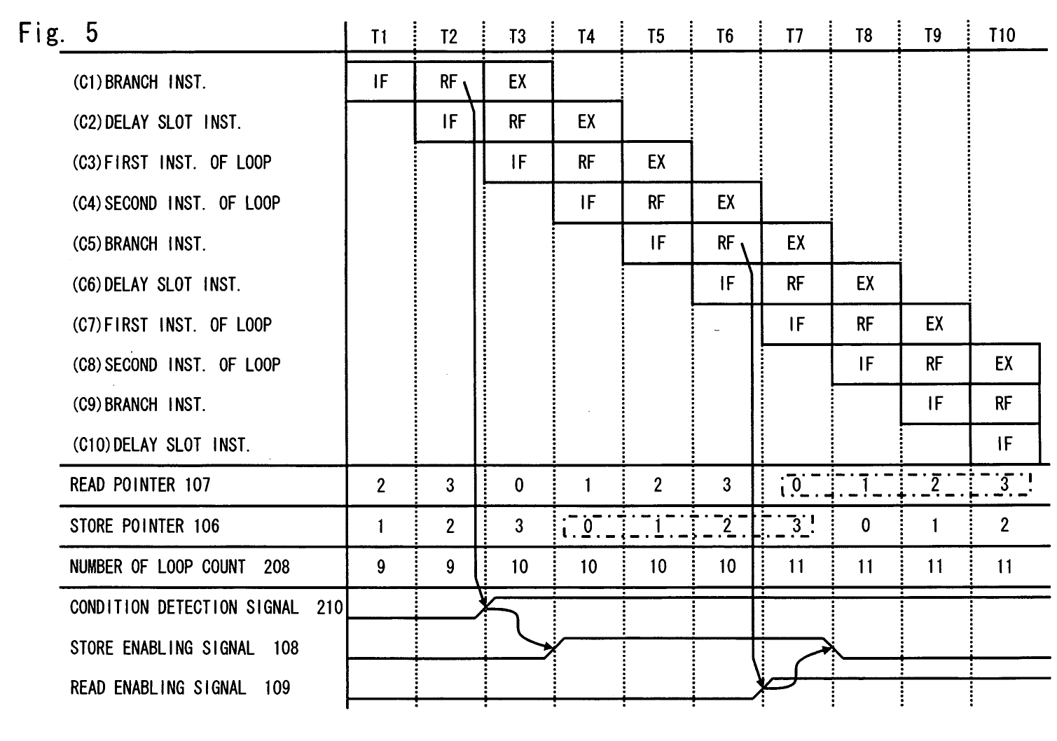

FIG. 5 is a timing diagram showing a process before starting cache access according to the first exemplary embodiment of the present invention. In particular, FIG. 5 shows storing and reading the way information, when an event wait condition is detected, for example, in an instruction loop including four instructions. In this case, as for a procedure from reading of an instruction from the cache memory 14 until execution of the instruction, address calculation (not shown), instruction reading (hereinafter referred to as “IF”), instruction decoding (hereinafter referred to as “RF”), and instruction execution (hereinafter referred to as “EX”) are carried out in this order and are each executed per cycle.

The way information read pointer 107 is a value of an internal counter of the instruction counter 85, counts up every time an instruction is executed, and is reset when the branch instruction detection signal 201 is high. That is, the way information read pointer 107 counts the number of instructions from a first instruction of the instruction loop to a branch instruction, during execution of the instruction loop. The way information store pointer 106 is a value obtained by latching the way information read pointer 107 by the flip flop 98.

The operation during cycles T1 and T10 of FIG. 5 is explained assuming that a threshold of the loop count number for determining the event wait condition is “10”. The instruction loop has been executed until the loop count number becomes “9”, before the cycle T1.

In the cycle T1, the cache device 1 reads a branch instruction C1 from the cache memory 14. At this point, the cache device 1 sets the way information store pointer 106 to “1”, and sets the way information read pointer 107 to “2”, continuously from the last cycle, because the executive instruction 104 is not a branch instruction.

In the cycle T2, the cache device 1 decodes the branch instruction C1, and reads a delay slot instruction C2 from the cache memory 14. At this point, the control circuit 80 determines that the executive instruction 104 is a branch instruction, sets the way information store pointer 106 to “2”, for the event wait condition, and sets the way information read pointer 107 to “3”.

In the cycle T3, the cache device 1 executes the branch instruction C1, decodes the delay slot instruction C2, and reads a first instruction C3 of a loop from the cache memory 14. At this point, the control circuit 80 sets the event wait condition detection signal 210 to high, sets the way information store pointer 106 to “3”, and sets the way information read pointer 107 to “0”.

In the cycle T4, the cache device 1 executes the delay slot instruction C2, decodes the first instruction C3 of the instruction loop, and reads a second instruction C4 of a loop from the cache memory 14. At this point, the control circuit 80 sets the way information store enabling signal 108 to high, sets the way information store pointer 106 to “0”, and sets the way information read pointer 107 to “1”. The way information administration unit 101 stores the way information of the first instruction C3 of the loop in an entry-0 indicated by the way information store pointer 106 in the way information buffer 79.

In the cycle T5, the cache device 1 executes the first instruction C3 of the loop, decodes the second instruction C4 of the loop, and reads a branch instruction C5 from the cache memory 14. At this point, the control circuit 80 sets the way information store pointer 106 to “1”, and sets the way information read pointer 107 to “2”. The way information administration unit 101 stores the way information of the second instruction C4 of the loop in an entry-1 indicated by the way information store pointer 106 in the way information buffer 79.

In the cycle T6, the cache device 1 executes the second instruction C4 of the loop, decodes the branch instruction C5, and reads a delay slot instruction C6 from the cache memory 14. At this point, the control circuit 80 sets the way information store pointer 106 to “2”, and sets the way information read pointer 107 to “3”. The way information administration unit 101 stores the way information of the branch instruction C5 to an entry-2 indicated by the way information store pointer 106 in the way information buffer 79.

In the cycle T7, the cache device 1 executes the branch instruction C5, decodes the delay slot instruction C6, and reads a first instruction C7 of a loop from the cache memory 14. At this point, the control circuit 80 sets the way information store enabling signal 108 to high, sets the way information store pointer 106 to “3”, and resets the way information read pointer 107. The way information administration unit 101 stores the way information of the delay slot instruction C6 in an entry-3 indicated by the way information store pointer 106 in the way information buffer 79. The way information administration unit 101 reads the way information of the first instruction C3 of the loop from an entry-0 indicated by the way information read pointer 107 in the way information buffer 79.

In the cycle T8, the cache device 1 executes the delay slot instruction C6, decodes the first instruction C7 of the loop, and reads a second instruction C8 of the loop from the cache memory 14. At this point, the control circuit 80 sets the way information store enabling signal 108 to low, sets the way information store pointer 106 to “0”, and sets the way information read pointer 107 to “1”. The way information administration unit 101 reads the way information of the second instruction C4 of the loop from an entry-1 indicated by the way information read pointer 107 in the way information buffer 79.

In the cycle T9, the cache device 1 executes the first instruction C7 of the loop, decodes the second instruction C8 of the loop, and reads a branch instruction C9 from the cache memory 14. At this point, the control circuit 80 sets the way information store pointer 106 to “1”, and sets the way information read pointer 107 to “2”. The way information administration unit 101 reads the way information of the branch instruction C5 from an entry-2 indicated by the way information read pointer 107 in the way information buffer 79.

In the cycle T10, the cache device 1 executes the second instruction C8 of the loop, decodes the branch instruction C9, and reads a delay slot instruction C10 from the cache memory 14. At this point, the control circuit 80 sets the way information store pointer 106 to “2”, and sets the way information read pointer 107 to “3”. The way information administration unit 101 reads the way information of the delay slot instruction C6 from an entry-3 indicated by the way information read pointer 107 in the way information buffer 79.

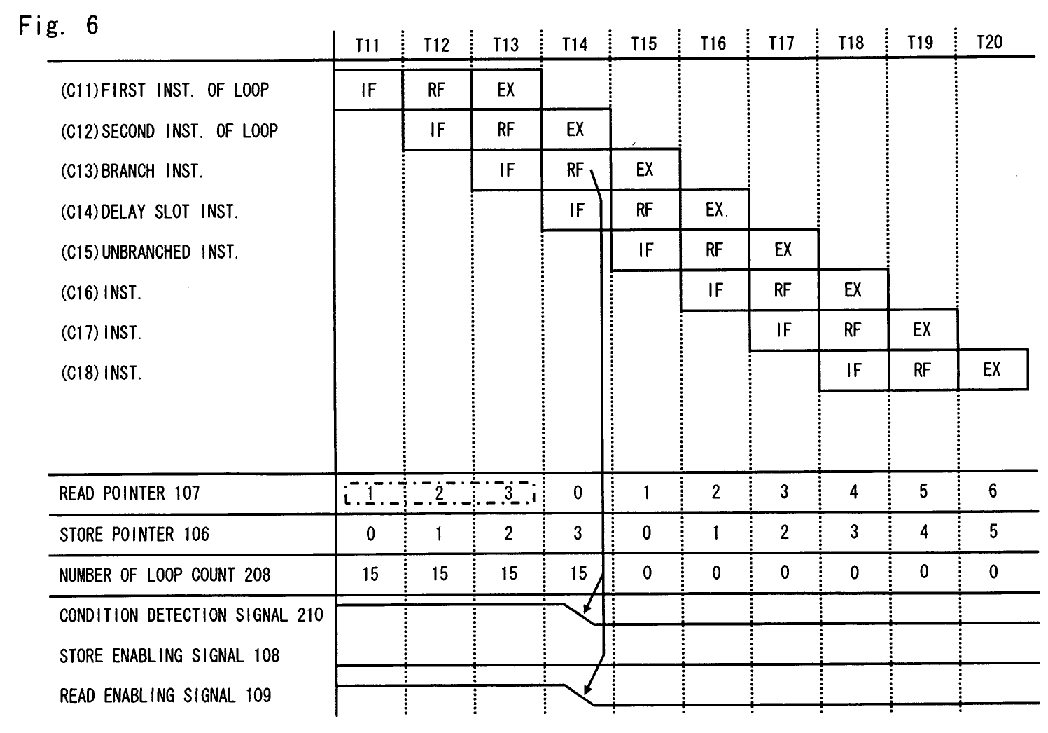

FIG. 6 is a timing diagram showing a process for detecting termination of an event wait condition detection according to the first exemplary embodiment of the present invention. Note that a cycle T11 is indicative of a point where the loop count number 208 has reached “15” after a predetermined number of cycles are performed, since the cycle T10. FIG. 6 shows that instructions C16 to C18 are arbitrary instructions.

In a cycle T13, the cache device 1 reads a branch instruction C13 from the cache memory 14. In a cycle T14, the cache device 1 decodes the branch instruction C13. In a cycle T15, the cache device 1 calculates the branch destination address 105 of the branch instruction C13.

At this point, the branch destination address 105 calculated in the cycle T15 is used to read an instruction from the cache memory 14 in the same cycle. In the cycle T15, the branch destination address comparator 93 compares the branch destination address 105 and the last branch destination address 203. When the comparison result shows a mismatch, the branch destination address comparator 93 sets the branch destination mismatch signal 207 to high. In the same cycle, the loop counter 86 resets the loop count number 208. The loop count number comparator 94 sets the event wait condition detection signal 210 to low. The way information buffer on/off control circuit 87 sets the way information read enabling signal 109 to low. Therefore, the event wait condition terminates. The cache device 1 executes a normal cache access from a cycle after a cycle T16.

As described above, the cache system in accordance with the first exemplary embodiment of the present invention stores only the way information in the instruction group to be repeatedly executed instead of matching addresses for way prediction. Therefore, only the way information of the instruction group is to be read. Consequently, the way prediction can be reliably made while the instruction group is repeatedly executed continuously. Therefore, it is possible to reduce the occurrence of a failure in the way prediction and prevent the system from causing a malfunction.

The reason is that way information is stored upon detection of the event wait condition in the first exemplary embodiment of the present invention. Therefore, the way information of all instructions in the event wait condition where a specific instruction loop is repeated is stored, in the way information buffer, and thus the way prediction can be reliably made.

Additionally, in the first exemplary embodiment of the present invention, the cache access can be made with low power consumption. The reason is that the control circuit 80 disables access to an unnecessary tag memory and data memory in the event wait condition. Therefore, the number of accesses to the cache memory can be reduced compared with normal cache access.

Note that the way information buffer 79 according to the first exemplary embodiment of the present invention does not hold a value of an address. In particular, the way information buffer 79 does not hold values of a tag and a set-index, unlike Japanese Unexamined Patent Application Publication No. 2006-120163 and Japanese Unexamined Patent Application Publication No. 2006-343803. Therefore, the capacity of the way information buffer 79 can be reduced. Alternatively, the way information buffer 79 can hold more entries, compared with Japanese Unexamined Patent Application Publication No. 2006-120163 and Japanese Unexamined Patent Application Publication No. 2006-343803. Therefore, it is possible to improve the accuracy of the way prediction.

In this way, in the first exemplary embodiment of the present invention, the cache device having the way prediction function includes the way information buffer and the control circuit. The way information buffer stores the way information of cache access executed in the event wait condition. The control circuit detects the event wait condition, controls a tab and data access only in the event wait condition, and controls storing and reading of the way information to the way information buffer. In this case, the way information buffer outputs the way information, which is held in an entry indicated by the way information read pointer, from the way selection information upon cache access, thereby preventing the system from causing a malfunction due to wrong cache access.

### Other Exemplary Embodiments

The processor equipped with the cache device 1 according to the first exemplary embodiment of the present invention may be included in any appropriate arrangement. Further, algorisms may be embodied in any suitable form (such as, a software format or a hardware format). For example, the processor may be a microprocessor, an independent integrated circuit, an application specific integrated circuit (ASIC), a field programmable gate array (FPGA), or any other suitable processing object, device, or a part of element. An address bus and a data bus are wires capable of carrying data (for example, binary data). Alternatively, the wires may be replaced with any other suitable technology (such as, optical radiation, a laser technology) operable to facilitate the propagation of data.

Further, the present invention is not limited to the above-described exemplary embodiments, and needless to say, various modifications can be made without departing from the spirit and scope of the present invention described above.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A cache system comprising:
a way information memory unit that stores way information that is a result of selecting a way in an instruction that accesses to a cache memory; and
a control unit that controls a storage processing and a read processing, while a series of instruction groups are repeatedly executed, the storage processing being for storing the way information in the instruction group to the way information memory, the read processing being for reading the way information from the way information memory.

2. The cache system according to claim 1, wherein
the control unit detects that the instruction groups are repeatedly executed, from a plurality of instructions to be supplied, and upon the detection, the control unit controls the storage processing and the read processing.

3. The cache system according to claim 2, wherein
when the control unit detects that the instruction groups are repeatedly executed, the control unit starts the storage processing for the way information in the instruction groups, and
after the storage processing is started, when the control unit detects that the instruction groups are executed again, the control unit starts the read processing.

4. The cache system according to claim 3, wherein
when the control unit detects that the same instruction group is executed immediately after the instruction groups detected are executed, the control unit starts the read processing.

5. The cache system according to claim 3, wherein
when the control unit detects that the same branch instruction is periodically executed, the control unit detects that the instruction groups are repeatedly executed.

6. The cache system according to claim 3, wherein
when a branch destination address included in the instruction groups detected does not match a branch destination address included in an instruction group obtained after the read processing is started, the control unit terminates the read processing.

7. The cache system according to claim 1, wherein
the control unit controls the storage processing to store the way information of instructions belonging to the instruction groups to the way information memory unit according to an order of executing the instructions, and controls the read processing to read the way information stored from the way information memory unit according to an order of storage in the way information memory unit.

8. The cache system according to claim 1, wherein
the control unit comprising:
a branch instruction determination circuit that decodes the plurality of instructions to be supplied and determines whether the instructions to be decoded are branch instructions or not;
a branch instruction address holding circuit that holds an address of a branch instruction executed last time;
a branch destination address holding circuit that holds an address of a branch destination of the branch instruction;
an instruction counter that counts up upon each execution of one instruction and is reset when the instruction is determined as a branch instruction; and
a loop counter that is used for a loop control of the plurality of instructions to be repeatedly executed.

9. A control method of way prediction for a cache memory in a cache device, comprising:
a cache memory;
a way information buffer that stores way information that is a result of selecting a way in an instruction that accesses the cache memory; and
a control unit that controls an operation of the way information buffer,
the control method comprising:
storing, by the control unit, the way information in a series of instruction groups to the way information buffer, while the instruction groups are repeatedly executed; and
reading, by the control unit, the way information from the way information buffer, while the instruction groups are repeatedly executed.

10. The control method according to claim 9, further comprising:
performing a first detection, by the control unit, to detect whether the instruction groups are repeatedly executed or not, from a plurality of instructions to be supplied; and
performing a second detection, by the control unit, to detect whether the instruction groups are executed again or not, when the control unit detects in the first detection that the instruction groups are repeatedly executed, wherein
starting, in the storing, the storage processing to the way information buffer for the way information in the instruction groups detected, when detecting in the first detection that the instruction groups are repeatedly executed; and
starting, in the reading, the read processing from the way information buffer, when detecting in the second detection that the instruction groups are executed again.

11. The control method according to claim 10, wherein
in the second detection, the control unit detects whether the same instruction group is executed or not immediately after the instruction groups detected are executed, and
in the reading, the control unit starts the read processing, when detecting in the second detection that the same instruction group is executed immediately after the instruction groups detected are executed.

12. The control method according to claim 10, wherein
in the first and second detections, the control unit detects whether the instruction groups are repeatedly executed or not, by determining whether the same branch instruction is periodically executed or not.

13. The control method according to claim 11, wherein
the control unit determines whether a branch destination address included in the instruction groups detected matches a branch destination address included in an instruction group obtained after the read processing is started and,
in the reading, when a result of the determination indicates a mismatch between the branch destination addresses, the control unit terminates the read processing.

14. The control method according to claim 9, wherein
in the storing, the control unit stores the way information of instructions belonging to the instruction groups to the way information buffer according to an order of executing the instructions, and
in the reading, the control unit reads the way information stored from the way information buffer according to an order of storage in the way information buffer.
